(19) United States
(12) Patent Application Publication
(10) Pub. No.: US 2010/0246708 A1
(43) Pub. Date: Sep. 30, 2010

(54) RADIO COMMUNICATION APPARATUS, RADIO COMMUNICATION METHOD, AND RADIO COMMUNICATION SYSTEM

(75) Inventors: Ayako Horiuchi, Kanagawa (JP); Daichi Imamura, Kanagawa (JP); Seigo Nakao, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/743,640

(22) PCT Filed: Nov. 19, 2008
(86) PCT No.: PCT/JP2008/003382

§ 371 Date: May 19, 2010

(30) Foreign Application Priority Data
Nov. 21, 2007 (JP) 2007-301658

(51) Int. Cl. H04L 25/49

(52) U.S. Cl. 375/286

(57) ABSTRACT

A radio communication apparatus, a radio communication method, and a radio communication system, which are capable of improving receiving reliability of predetermined bits such as bits having a high degree of importance, and the like, are provided. A code length L is decided based on the modulation system and the coding rate being specified, and the bit length of S2. The relay station decides a coding rate of S1 from the code length L. In the case of 16 QAM, since a half of all bits correspond to the bits used as the object of the quadrant discrimination, the bit length of S1 is set to L/2. Therefore, the coding rate of S1 is 2(LS1)/L, where the bit length of S1 is LS1. In the present example, S1 is coded and gives S1+P1, and S2 is coded and gives S2+P4. P1 denotes the parity bit of S1, and P4 denotes the parity bit of S2. The relay station changes the bit arrangement such that all bits of the code word (S1+P1) of S1 come to the position of the quadrant discrimination in the constellation of 16 QAM respectively.

### TECHNICAL FIELD

The present invention relates to a radio communication apparatus, a radio communication method, and a radio communication system for making a reception of a first signal from a first radio communication apparatus, a reception of a second signal from a second radio communication apparatus, and a transmission of a third signal to the first radio communication apparatus and the second radio communication apparatus.

### BACKGROUND ART

In recent years, with the progress of multimedia to handle the information, it has become a common practice that, in the cellular mobile communication system, not only the sound data but also the large amount of data such as static image data, video data, etc should be transmitted. In order to realize the transmission of the large amount of data, the study of the technology of attaining a high transmission rate by utilizing a high-frequency radio band is eagerly conducted now.

However, when a high-frequency radio band is utilized, a high transmission rate can be expected in a short-distance transmission whereas attenuation caused due to a transmission distance is increased as the transmission distance becomes longer. Therefore, when the mobile communication system utilizing a high-frequency radio band is put actually into service, a coverage area of a radio communication base station apparatus (referred simply to as a “base station” hereinafter) becomes small, and accordingly the necessity of installing a larger number of base stations arises. Since the installation of the base stations entails enormous cost, the technology to implement the communication service utilizing a high-frequency radio band while suppressing an increase of the number of base stations is strongly demanded.

According to such demand, in order to extend the coverage area of each base station, such a relay transmitting technology is studied that a radio communication relay station apparatus (referred simply to as a “relay station” hereinafter) is provided between the base station and a radio communication mobile station apparatus (referred simply to as a “mobile station” hereinafter) and then a communication between the base station and the mobile station is held via the relay station. By using the relay technology, the terminal that cannot directly hold a communication with the base station can hold a communication via the relay station.

However, the necessity of maintaining the resource that relay station transits arises in the relay technology, and therefore the effective utilization of the resource becomes a problem. As the method of solving this problem, an application of a network coding (a coding process in the network) to the relay station is studied.

First, a network coding will be explained with reference to FIG. 21 hereunder. In the radio communication system built up by the mobile station, the relay station, and the base station, the mobile station transmits a signal to the base station via the relay station, and the base station transmits a signal to the mobile station via the relay station. The mobile station transmits a signal S1 to the relay station. Here, the signal S1 is assumed as a bit string of 1111 by way of example. The base station transmits a signal S2 to the relay station.

Here, the signal S2 is assumed as a bit string of 1010 by way of example.

The relay station calculates an XOR (exclusive OR) of S1 and S2 bit by bit, and then transmits 0101 as the calculated result of 1111 XOR 1010 to the mobile station and the base station. At this time, the resource that the relay station employs in the transmission corresponds to the resource that both the mobile station and the relay station can receive.

The mobile station calculates the XOR of the received 0101 and S1 (1111) that the mobile station transmits to the relay station, and receives 1010 as the calculated result of 0101 XOR 1111. Similarly, the base station calculates the XOR of the received 0101 and S2 (1010) that the base station transmits to the relay station, and receives 1111 as the calculated result of 0101 XOR 1010.

In this manner, when the network coding that calculates the XOR is applied to the relay, S1 and S2 can be transmitted by the same resource at the same time. As a result, the effective utilization of the resource can be achieved in contrast to the case where S1 and S2 are independently transmitted respectively.

Here, the signals S1 and S2 that are subjected to the network coding are not always equal in length of the bit string. Therefore, in order to make the length of the bit string uniform, it has been proposed that the bit-string length is adjusted by using ◯ padding, repetition, coding rate, and the like (see Patent Literature 1, for example). Also, the method of constellating the bit on different signal points in the first-time transmission and the retransmission has been proposed by focusing attention on the constellation (positions of the signal points) of the multilevel modulation (see Non-Patent Literature 1, for example).

Patent Literature 1: US 2007/0184826(A 1)

Non-Patent Literature 1: Enhanced HARQ Method with Signal Constellation Rearrangement, 3GPP, TSG-RAN Working Group 1 Meeting #19 TSGR#19(01) 0237, March 2001

### DISCLOSURE OF THE INVENTION

### Problems that the Invention is to Solve

However, in the above method in the prior art, when a receiving quality of the bits having a high degree of importance is low in transmitting collectively the bit strings that underwent the XOR operation, a degradation of the error rate characteristic occurs. In particular, in the above method in the prior art, the constellation of the bits having the high degree of importance and the bits having a low degree of importance in the bit strings is not taken into consideration. Therefore, when the multilevel modulation is applied, in some cases the bit having the high degree of importance is arranged in the position whose reliability is low and thus the error rate is increased. Also, with regard to the signal whose original signal has a short bit-string length, such a problem still exists that the resource cannot be effectively utilized upon extending the bit string length.

The present invention has been made in light of the circumstances in the prior art, and it is an object of the present invention to provide a radio communication apparatus, a radio communication method, and a radio communication system capable of improving receiving reliability of predetermined bits such as bits having the high degree of importance, and the like.

### Means for Solving the Problems

A radio communication apparatus of the present invention for performing a reception of a first signal from a first radio communication apparatus, a reception of a second signal from a second radio communication apparatus, and a transmission of a third signal to the first radio communication apparatus and the second radio communication apparatus, includes an exclusive logical sum operating section that generates the third signal by performing an exclusive logical sum operation of a code word of the second signal and a code word of the first signal, which is arranged in a position of a quadrant discrimination bit in a multilevel modulation, bit by bit on a basis of a code length of the second signal.

According to the above configuration, the code word of the first signal is constellated in the position of the quadrant discrimination bit, and then the exclusive logical sum of the code word of the second signal and the code word of the first signal is calculated. Therefore, the bit having the high degree of importance can be transmitted to the position of the quadrant discrimination bit, which has high tolerance for the noise and the interference, as the first signal. As a result, the receiving reliability of the bit having the high degree of importance can be improved.

Also, a radio communication apparatus of the present invention further includes a zero padding section that inserts a zero into bit positions except the position of the quadrant discrimination bit in a bit string of the code word of the first signal so that a code length of the first signal becomes equal to a code length of the second signal.

According to the above configuration, the exclusive logical sum operation of the first signal and the second signal can be performed not to change the distance of the code word of the second signal from the center of the constellation. Therefore, the above configuration possesses such an effect that reliability is not changed due to the constellation of the second signal. Therefore, such an advantage exists that the above configuration is readily adaptable to the system in which the receiving quality is made uniform by changing the constellation position in the retransmission

Also, in the radio communication apparatus of the present invention, the exclusive logical sum operating section generates the third signal by performing the exclusive logical sum operation of the code word of the second signal and the code word of the first signal, in which predetermined bits are arranged in the position of the quadrant discrimination bit and a bit except the predetermined bits is arranged in a bit position except the quadrant discrimination bit, bit by bit.

According to the above configuration, only the predetermined bits of the code word of the first signal are arranged in the position of the quadrant discrimination bit, and then the exclusive logical sum operation of the code word of the first signal and the code word of the second signal is performed. Therefore, only the predetermined bits of the first signal after the coding can be transmitted to the position of the quadrant discrimination bit that has high tolerance for the noise and the interference. As a result, the receiving reliability of the predetermined bits in the bit string can be improved.

Also, a radio communication apparatus of the present invention further includes a bit rearranging section that arranges a bit, having a high degree of importance, of the code word of the first signal in the position of the quadrant discrimination bit.

In the prior art, the signal is coded to extend the bit string and then the signal is simply assigned to the bits. Therefore, often the bits having the high degree of importance are arranged in the bit position other than the position of the quadrant discrimination bit, and hence the resource could not be effectively utilized. In contrast, according to the above configuration, the bits having the high degree of importance out of the code word of the first signal are arranged in the position of the quadrant discrimination bit. Therefore, the receiving reliability of the bits having the high degree of importance can be improved, and the resource can be effectively utilized.

Also, in the radio communication apparatus of the present invention, the bit rearranging section arranges any bit of a signal containing a systematic bit, a control signal, a sound signal, and a signal transmitted for a first time in the position of the quadrant discrimination bit.

Also, in the radio communication apparatus of the present invention, a bit string length of the predetermined bits arranged in the position of the quadrant discrimination bit is within 2 L/(log₂M), where L is a length of the bit string that is subjected to the exclusive logical sum operation, and M is a number of multilevel in the multilevel modulation.

Also, a radio communication method of the present invention of performing a reception of a first signal from a first radio communication apparatus, a reception of a second signal from a second radio communication apparatus, and a transmission of a third signal to the first radio communication apparatus and the second radio communication apparatus, includes an exclusive logical sum operating step of generating the third signal by performing an exclusive logical sum operation of a code word of the second signal and a code word of the first signal, which is arranged in a position of a quadrant discrimination bit in a multilevel modulation, bit by bit on a basis of a code length of the second signal.

Also, a radio communication method of the present invention further includes a zero padding step of inserting a zero into bit positions except the position of the quadrant discrimination bit in a bit string of the code word of the first signal so that a code length of the first signal becomes equal to a code length of the second signal.

Also, in the radio communication method of the present invention, in the exclusive logical sum operating step, the third signal is generated by performing the exclusive logical sum operation of the code word of the second signal and the code word of the first signal, in which predetermined bits are arranged in the position of the quadrant discrimination bit and a bit except the predetermined bits is arranged in a bit position except the quadrant discrimination bit, bit by bit.

Also, a radio communication method of the present invention further includes a bit rearranging step of arranging a bit, having a high degree of importance, of the code word of the first signal in the position of the quadrant discrimination bit.

Also, in the radio communication method of the present invention, in the bit rearranging step, any bit of a signal containing a systematic bit, a control signal, a sound signal, and a signal transmitted for a first time is arranged in the position of the quadrant discrimination bit.

Also, in the radio communication method of the present invention, a bit string length of the predetermined bits arranged in the position of the quadrant discrimination bit is within 2 L/(log₂M), where L is a length of the bit string that is subjected to the exclusive logical sum operation, and M is a number of multilevel in the multilevel modulation.

Also, a radio communication system of the present invention, includes a first radio communication apparatus; a second radio communication apparatus; and a third radio communication apparatus for performing a reception of a first signal from the first radio communication apparatus, a reception of a second signal from the second radio communication apparatus, and a transmission of a third signal to the first radio communication apparatus and the second radio communication apparatus. The third radio communication apparatus includes an exclusive logical sum operating section that generates the third signal by performing an exclusive logical sum operation of a code word of the second signal and a code word of the first signal, which is arranged in a position of a quadrant discrimination bit in a multilevel modulation, bit by bit on a basis of a code length of the second signal.

### ADVANTAGES OF THE INVENTION

According to the present invention, the code word of the first signal is constellated in the position of the quadrant discrimination bit, and then the exclusive logical sum of the code word of the second signal and the code word of the first signal is calculated. Therefore, the bit having the high degree of importance can be transmitted to the position of the quadrant discrimination bit, which has high tolerance for the noise and the interference, as the first signal.

As a result, the receiving reliability of the bit having the high degree of importance can be improved.

### BRIEF DESCRIPTION OF THE DRAWINGS

FIG. 1 A view showing an operational example when a modulating system is 16 QAM, in a radio communication method according to a first embodiment of the present invention.

FIG. 2 An explanatory view of a constellation of 16 QAM.

FIG. 3 An explanatory view of a constellation of 8 PSK.

FIG. 4 A view showing an operational example when a modulating system is 8 PSK, in the radio communication method according to the first embodiment of the present invention.

FIG. 5 An explanatory view of a constellation of 64 QAM.

FIG. 6 A view showing an operational example when a modulating system is 64 QAM, in the radio communication method according to the first embodiment of the present invention.

FIG. 7 A block diagram showing a configuration of a relay station apparatus according to the first embodiment of the present invention.

FIG. 8 A block diagram showing a configuration of a mobile station apparatus according to the first embodiment of the present invention.

FIG. 9 A view showing an operational example when a modulating system is 16 QAM, in a radio communication method according to a second embodiment of the present invention.

FIG. 10 A view showing an operational example when a modulating system is 8 PSK, in the radio communication method according to the second embodiment of the present invention.

FIG. 11 A view showing an operational example when a modulating system is 64 QAM, in the radio communication method according to the second embodiment of the present invention.

FIG. 12 A block diagram showing a configuration of a relay station apparatus according to the second embodiment of the present invention.

FIG. 13 A block diagram showing a configuration of a mobile station apparatus according to the second embodiment of the present invention.

FIG. 14 An explanatory view when a bit whose degree of importance is low is a repetition of a bit whose degree of importance is high, in the second embodiment of the present invention.

FIG. 15 A view showing a configuration of a radio communication system according to a third embodiment of the present invention.

FIG. 16 A sequence diagram of the radio communication system according to the third embodiment of the present invention.

FIG. 17 A view showing an operational example when a modulating system is 16 QAM, in the radio communication system according to the third embodiment of the present invention.

FIG. 18 A block diagram showing a configuration of a relay station apparatus according to the third embodiment of the present invention.

FIG. 19 A block diagram showing a configuration of a mobile station apparatus according to the third embodiment of the present invention.

FIG. 20 A view showing an assignment of a quadrant discrimination bit when code lengths are different, in the radio communication system according to the third embodiment of the present invention.

FIG. 21 An explanatory view of a network coding.

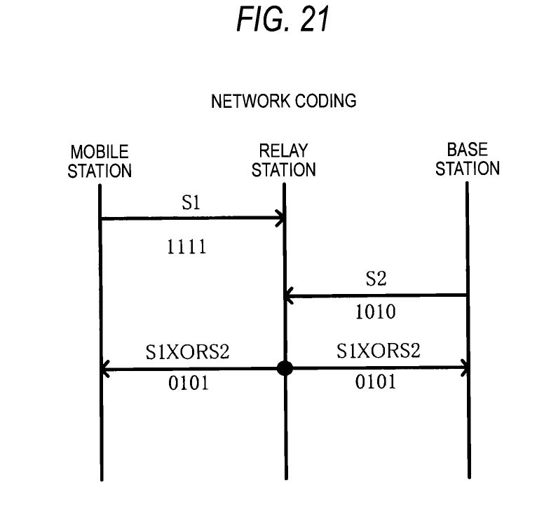

### DESCRIPTION OF REFERENCE NUMERALS

1 mobile station
2 mobile station
3 relay station
4 base station
11, 12 error correction coding portion
13 zero padding portion
14 XOR portion
15 modulating portion
16 radio transmitting portion
17, 24 antenna
18, 19 error correction decoding portion
20, 21 LLR portion
22 signal separating portion
23 radio receiving portion
25 bit rearranging portion
35 bit converting portion
36 bit selecting portion
37 buffer portion
39 bit operating portion
55, 56 bit string converting portion

### BEST MODE FOR CARRYING OUT THE INVENTION

### Embodiment 1

In the present embodiment, in applying the network coding by using a combination of the signal having a long bit length and the signal having a short bit length while using the multilevel modulation, in the 16 QAM, the signal having the short bit length is coded based on a half length of the signal having the long bit length, and is arranged in the position of the bit that discriminates the quadrant (quadrant discrimination bit), i.e., only in the bit that decides the quadrant of constellation. By doing this, such an advantage can be achieved that, even when the XOR operation of the signal having the long bit length and the signal having the short bit length is performed, reliability of the signal having the long bit length is not changed by the constellation. Also, when the signal having the short bit length is received, such signal can be received based on the decision of QPSK.

In applying the multilevel modulation, the number of bits acting as the quadrant discrimination is two bits per one symbol. The number of bits acting as the quadrant discrimination is 2 bits out of 4 bits of the 16 QAM, such number of bits is 2 bits out of 3 bits of the 8 PSK, and such number of bits is 2 bits out of 6 bits of the 64 QAM. Operations of respective modulation systems will be explained hereunder.

### Example of 16 QAM Operation

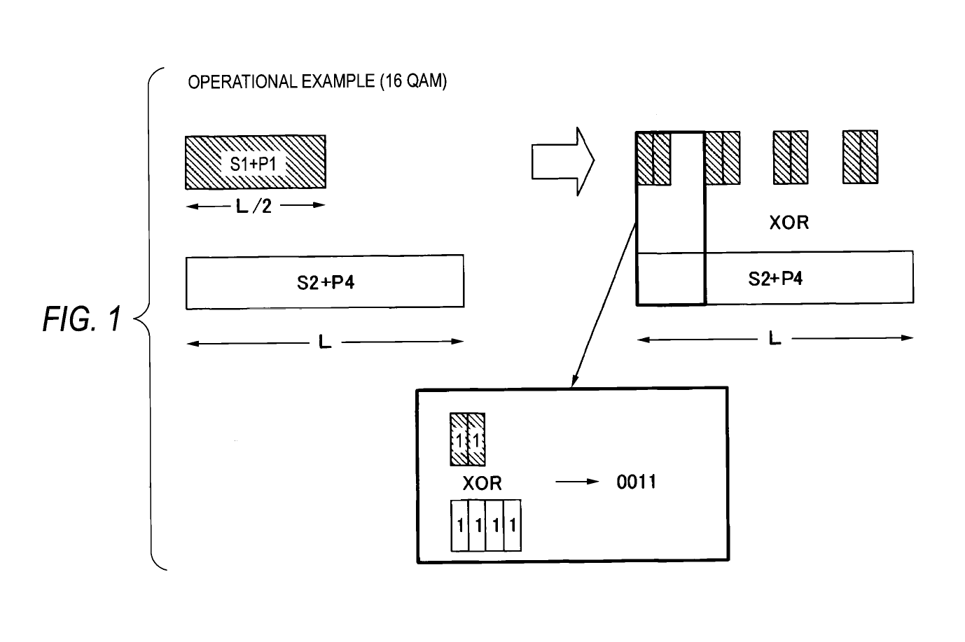

An operational example when a modulating system is 16 QAM is shown in FIG. 1. The relay station receives the signal S1 from the mobile station and receives the signal S2 from the base station, then applies the network coding to two signals, i.e., calculates the exclusive logical sum (XOR) of two signals, and then transfers the calculated result. In the present example, the network quality between the relay station and the mobile station is low among the network qualities between the relay station and the mobile station and between the relay station and the base station, and thus the modulation system and the coding rate are decided on a basis of the network quality between the relay station and the mobile station. The base station decides the modulation system and the coding rate, and instructs the relay station to apply the modulation system and the coding rate.

In the present example, in a case that 16 QAM is specified as the modulation system, a code length L is decided based on the modulation system and the coding rate being specified, and the bit length of S2. The relay station decides a coding rate of S1 based on the code length L. In the case of 16 QAM, since a half of all bits correspond to the bits used as the object of the quadrant discrimination, the bit length of S1 is set to L/2. Therefore, the coding rate of S1 is 2(LS1)/L, where the bit length of S1 is LS1. In the present example, S1 is coded and gives S1+P1, and S2 is coded and gives S2+P4. P1 denotes the parity bit of S1, and P4 denotes the parity bit of S2.

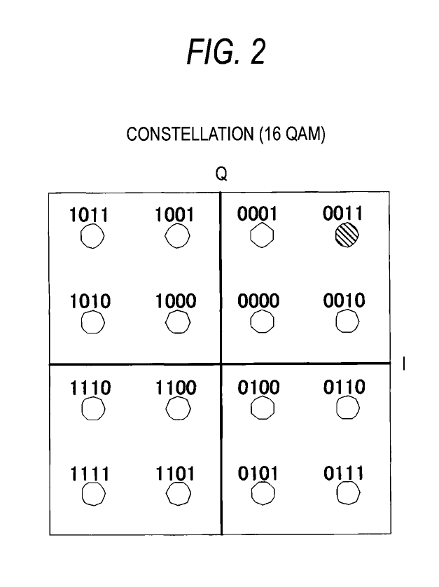

The relay station changes the bit arrangement such that all bits of the code word (S1+P1) of S1 come to the position of the quadrant discrimination in the constellation of 16 QAM respectively. In the present example, the constellation in FIG. 2 is employed. In the constellation in FIG. 2, the bits used as the object of the quadrant discrimination are the first bit and the second bit.

The relation between the constellation and the bits will be explained hereunder. The first bit denotes the right side or the left side in the I direction (the right side or the left side with respect to the Q axis), the third bit denotes the inside or the outside in the I direction (whether a distance to the Q axis is short or long), the second bit denotes the upper side or the lower side in the Q direction (the upper side or the lower side with respect to the I axis), and the fourth bit denotes the inside or the outside in the Q direction (whether a distance to the I axis is short or long). At this time, the first bit and the second bit act as the bits to decide the quadrant on the coordinate axis of the constellation.

According to a combination of the first bit and the second bit, the first quadrant is decided when the first bit and the second bit are (0, 0), the second quadrant is decided when the first bit and the second bit are (1, 0), the third quadrant is decided when the first bit and the second bit are (1, 1), and the fourth quadrant is decided when the first bit and the second bit are (0, 1).

The first bit and the second bit, which are decided according to the quadrant, have such a feature that the tolerance for the noise and the interference is higher than the third bit and fourth bit, which decide the inside or the outside of the constellation, and thus the receiving reliability becomes higher.

Therefore, when the important bits are arranged at the first bit and the second bit, the receiving reliability of the important bits can be improved.

The code word of S1 is arranged at the first bit and the second bit that are used for the quadrant discrimination, and the third bit and fourth bit are not used. Therefore, as shown in FIG. 1, the XOR operation of the bits 1111 of S2+P4 and bits 11 of S1+P1 is applied only to the first bit and the second bit, and a transmit bit string of 0011 is given.

In this manner, when the bits of the short code word (code word of S1) are arranged only in the position used for the quadrant discrimination, the information is transmitted only to the bits whose receiving reliability is higher. Therefore, a receiving quality is improved on the receiving side. Also, since the bits of the short code word (code word of S1) are arranged only in the positions that are used for the quadrant discrimination, the position of the constellation of the bit string after the XOR operation located on the inner side is still kept on the inner side, in comparison with the position of the constellation of the long code word (code word of S2), and also the position of the constellation located on the outer side is still kept on the outer side.

By way of example, when the bit string of S2+P4 is 1111, the position of 1111 is located at the lower left end of the third quadrant in the constellation in FIG. 2. As shown in FIG. 1, the transmit bit string derived when the XOR of only the quadrant discrimination bit out of 1111 (S2+P4) and 11(S1+P1) is calculated becomes 0011. The position of 0011 is located at the upper right end of the first quadrant in the constellation in FIG. 2.

For example, the transmit bit string becomes 0111 when the bit string of S1+P1 is 10, and the transmit bit string becomes 1011 when the bit string of S1+P1 is 01. The bit strings 0111 and 1011 are located at the upper left end and the lower right end respectively. All distances of these bit strings from a center of the coordinate axes are equal. In this manner, when XOR is applied only to the bit position used for the quadrant discrimination, the bits can be transformed not to change the distance from the center of the constellation.

### Example of 8 PSK Operation

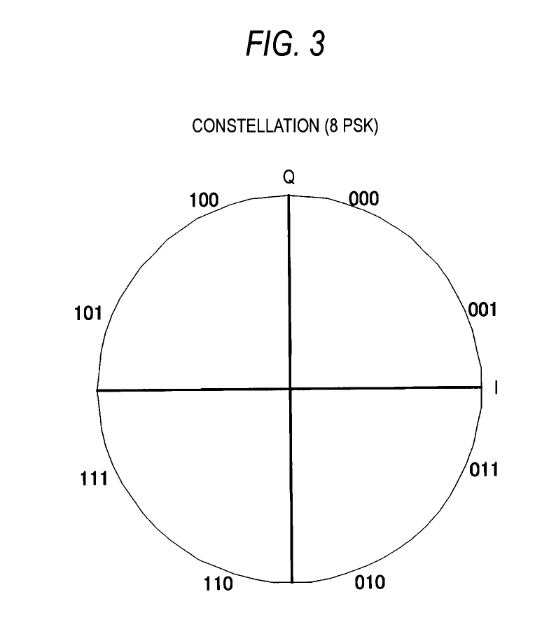

When 8 PSK is employed as the modulation system, the object of the quadrant discrimination out of three bits constituting the symbol is two bits. In the present example, the constellation shown in FIG. 3 is employed. In the constellation in FIG. 3, the bits as the object of the quadrant discrimination are the first bit and the second bit. The important bit is arranged at the first bit and the second bit acting as the object of the quadrant discrimination, and the unimportant bit is arranged at the third bit.

A relation between the constellation and the bits will be explained with reference to FIG. 3 hereunder. The first bit denotes the right side or the left side in the I direction (the right side or the left side with respect to the Q axis), the second bit denotes the upper side or the lower side in the Q direction (the upper side or the lower side with respect to the I axis), and the third bit denotes whether the bit is close to the I axis or the Q axis in the same quadrant.

At this time, like the case of 16 QAM, the first bit and the second bit act as the bits that decide the quadrant of the constellation on the coordinate axes. Therefore, when the important bit is arranged at the first bit and the second bit, the receiving reliability of the important bits can be improved.

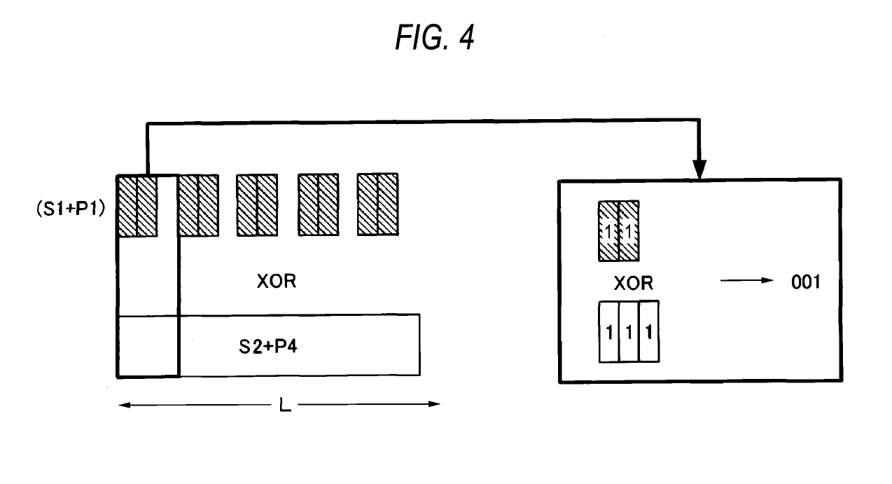

When the arrangement in FIG. 3 is employed as the constellation, the first bit and the second bit are used for the quadrant discrimination. Therefore, the code word (S1+P1) as the shorter code word is arranged at the first bit and the second bit, and no code word is arranged at the third bit (see FIG. 4).

### Example of 64 QAM Operation

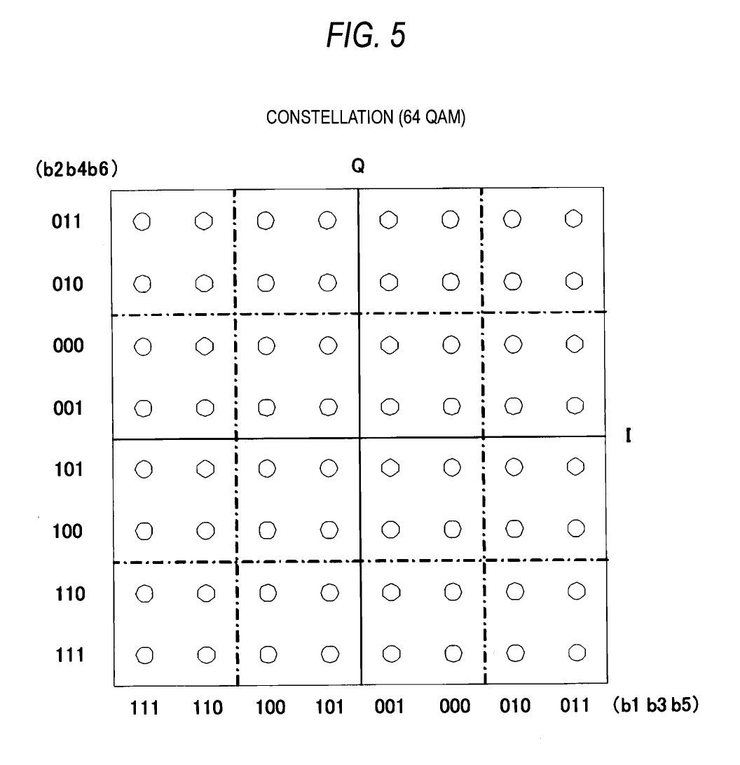

When 64 QAM is employed as the modulation system, the object of the quadrant discrimination out of six bits constituting the symbol is two bits. In the present example, the constellation shown in FIG. 5 is employed. In the constellation in FIG. 5, the bits as the object of the quadrant discrimination are the first bit and the second bit. The important bit is arranged at the first bit and the second bit acting as the object of the quadrant discrimination, and the unimportant bit is arranged at the third to sixth bits.

A relation between the constellation and the bits will be explained with reference to FIG. 5 hereunder. The first bit denotes the right side or the left side in the I direction (the right side or the left side with respect to the Q axis), and the second bit denotes the upper side or the lower side in the Q direction (the upper side or the lower side with respect to the I axis). The third bit splits roughly the same quadrant into the right side and the left side, and the fourth bit splits roughly the same quadrant into the upper side and the lower side. That is, the third bit denotes that which one of two parts, which are obtained by splitting each quadrant bilaterally, has a shorter (or longer) distance from the Q axis, and the fourth bit denotes that which one of two parts, which are obtained by splitting each quadrant vertically, has a shorter (or longer) distance from the I axis. Also, the fifth bit splits finely the same part into the right side and the left side, and the sixth bit splits finely the same part into the upper side and the lower side. That is, the fifth bit denotes which one of four-way split parts of each quadrant has a shorter (or longer) distance from a straight line that splits each quadrant bilaterally into two parts, and the sixth bit denotes which one of four-way split parts of each quadrant has a shorter (or longer) distance from a straight line that splits each quadrant bilaterally into two parts.

At this time, like the case of 16 QAM, the first bit and the second bit act as the bits that decide the quadrant of the constellation on the coordinate axes. Therefore, when the important bit is arranged at the first bit and the second bit, the receiving reliability of the important bits can be improved.

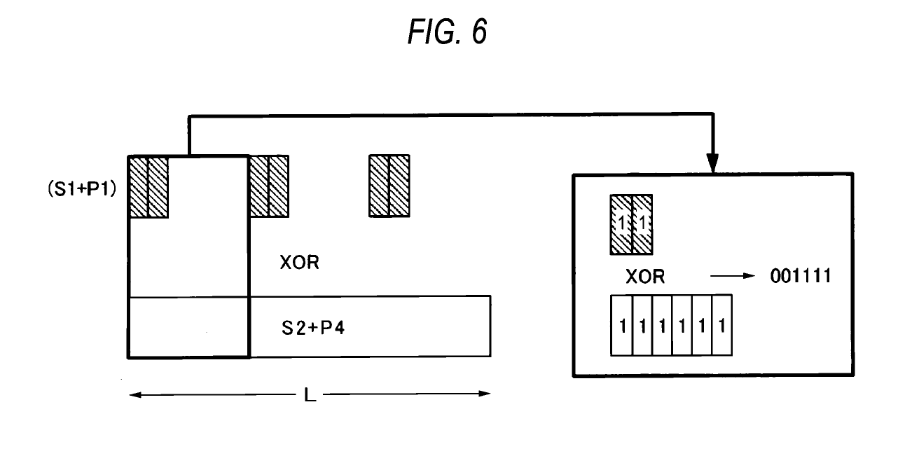

When the arrangement in FIG. 5 is employed as the constellation, the first bit and the second bit are used for the quadrant discrimination. Therefore, the code word (S1+P1) as the shorter code word is arranged at the first bit and the second bit, and no code word is arranged at the third to sixth bits (see FIG. 6).

### Block Diagram of Relay Station

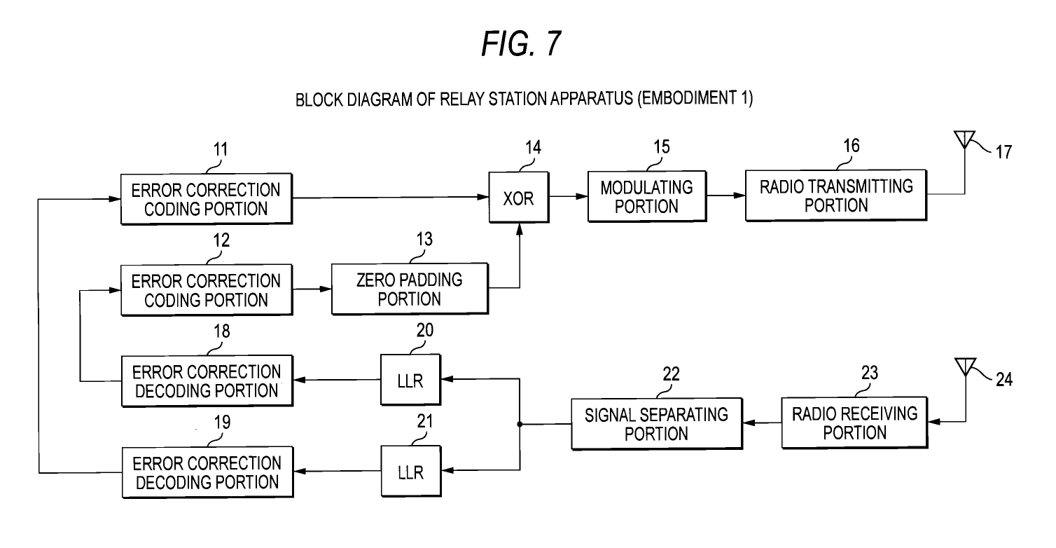

FIG. 7 is a block diagram showing a configuration of a relay station apparatus according to the present embodiment. A radio receiving portion 23 receives a signal from the mobile station and a signal from the base station via an antenna 24, and applies a radio process such as down-convert, or the like to the signals and outputs the resultant signal to a signal separating portion 22.

The signal separating portion 22 separates the resultant signal into a signal S1 received from the mobile station and a signal S2 received from the base station. The separated signals are output to LLR portions 20, 21 respectively. The LLR portions 20, 21 calculate a logarithmic likelihood ratio (LLR: Log Likelihood Ratio) as the soft decision value to the signal S1 received from the mobile station and the signal S2 received from the base station respectively, and output the logarithmic likelihood ratio to error correction decoding portions 18, 19 respectively.

The error correction decoding portions 18, 19 make the error correction of the signal S1 received from the mobile station and the signal S2 received from the base station by using the LLR, and decode the signals. Then, error correction coding portions 11, 12 encode the signals that underwent the error correction decoding in the error correction decoding portions 18, 19 respectively, and output the signal to an XOR portion 14 via a zero padding portion 13 or output the signal to the XOR portion 14 directly. The zero padding portion 13 inserts ◯ into the bit string of the short code word to make the length of the bit string of the code word uniform when it applies the XOR to the long code word. This ◯ may be inserted into the positions other than the positions where the bits as the object of the quadrant discrimination are arranged. The XOR operation of the long code word and ◯ is equivalent to the event that the long code word is output as it is.

The XOR portion 14 performs the XOR operation of both the signal that is subjected to the error correction coding in the upper link and the signal into which ◯ is inserted after the error correction coding is applied in the lower link, and then outputs the resultant signal to a modulating portion 15. The modulating portion 15 modulates again both the signal from the mobile station and the signal from the base station, which are underwent the XOR operation, and outputs the modulated signal to a radio transmitting portion 16. The radio transmitting portion 16 applies the radio process such as up-convert, or the like to the modulated signal, and relays/transmits the processed signal to the mobile station and the base station via an antenna 17.

### Block Diagram of Mobile Station

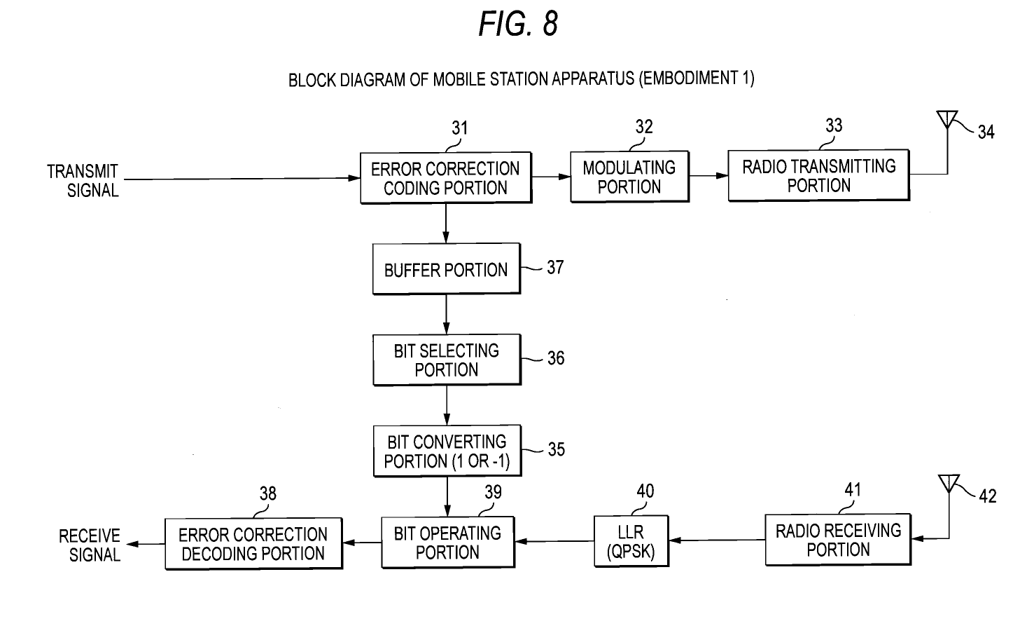

FIG. 8 is a block diagram showing a configuration of a mobile station apparatus that receives the short code word according to the present embodiment. An explanation of the similar parts to those of a block diagram of the relay station in FIG. 7 will be omitted herein. A buffer portion 37 saves the signal that is subjected to the error correction coding, and outputs the signal to a bit selecting portion 36. The bit selecting portion 36 selects the bit, which is assigned to the bit as the object of the quadrant discrimination at the relay station, out of the signals that the mobile station transmits to the relay station, and outputs the bit to a bit converting portion 35. The bit converting portion 35 converts the bit into −1 when the signal being output from the buffer portion 37 is 1 and converts the bit into 1 when such signal is 0, and generates the bit string and then outputs this bit string to a bit operating portion 39.

A LLR (QPSK) portion 40 calculates the logarithmic likelihood ratio (LLR: Log Likelihood Ratio) as the soft decision value to the signal received from the mobile station and the signal received from the base station bit by bit, and outputs the logarithmic likelihood ratio to the bit operating portion 39. At this time, the signal is put only on the position corresponding to the quadrant discrimination bit in the short code word, and therefore the LLR portion 40 calculates LLR of the received signal by the QPSK. The bit operating portion 39 multiplies the signal being output from the LLR portion 40 by the signal being output from the bit converting portion 35 every element. When an output of the LLR portion 40 is “I1 I2 I3 I4” and an output of the bit converting portion 35 is “b1 b2 b3 b4”, the multiplied signal is given by “I1b1 I2b3 I3b3 I4b4”. The multiplied signal is output to an error correction decoding portion 38.

In the present embodiment, the XOR operation can be performed not to change the distance of the long code word from the center of the constellation. Therefore, such an advantage exists that the present embodiment is readily adaptable to the system in which the receiving quality is made uniform by changing the constellation position in the retransmission, as shown in Non-Patent Literature 1.

In this case, the code word that is transmitted only to the position used for the quadrant discrimination may have the code word length that is 2 L/log₂ (M) or less. Also, the position of the constellation is not limited to this pattern. A bit-shifted pattern, a bit-inverted pattern, a bit-exchanged pattern, or their combination may be employed. According to the used pattern of the constellation, the position of the quadrant discrimination bit is different.

When the coding used when the mobile station transmits the signal to the relay station and the coding used when the relay station transmits the signal to the mobile station are different, the mobile station generates the signal that is to be coded in the relay station and executes the bit calculation.

Also, in the present example, only the signal sent from the mobile station is arranged in the position used for the quadrant discrimination. In this case, only the signal sent from the base station may be arranged in the position used for the quadrant discrimination.

### Embodiment 2

In the present embodiment, when the network coding is established by using the multilevel modulation while using a combination of the signal having a long bit length and the signal having a short bit length, the signals are combined mutually such that the signals having the short bit length are coded, the bit whose degree of importance is high is arranged at the bit that is used for the quadrant discrimination, and the bit whose degree of importance is low is arranged at the bit that is not used for the quadrant discrimination. By doing this, the receiving reliability of the bit whose degree of importance is high can be improved rather that the receiving reliability of the bit whose degree of importance is low.

As described above, in the multilevel modulation, the number of bits as the object of the quadrant discrimination is two bits per symbol. The object of the quadrant discrimination is two bits out of four bits in 16 QAM, such object is two bits out of three bits in 8 PSK, and such object is two bits out of six bits in 64 QAM. Respective operations of the modulation systems will be explained hereunder.

### Example of 16 QAM Operation

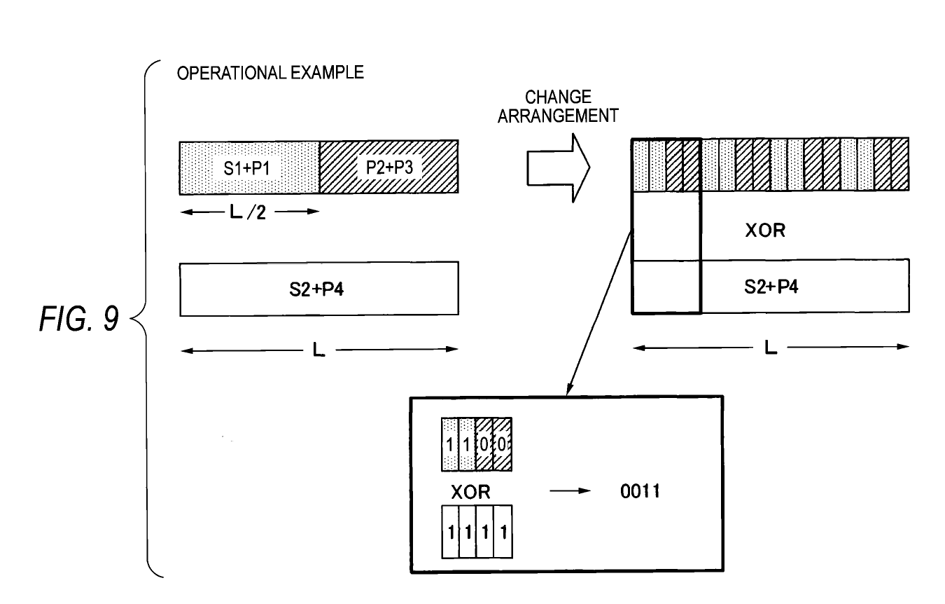

An operational example when a modulating system is 16 QAM is shown in FIG. 9. The relay station receives the signal S1 from the mobile station and receives the signal S2 from the base station, then applies the network coding to two signals, and then transfers the calculated result. In the present example, the network quality between the relay station and the mobile station is low among the network qualities between the relay station and the mobile station and between the relay station and the base station, and thus the modulation system and the coding rate are decided on a basis of the network quality between the relay station and the mobile station. The base station decides the modulation system and the coding rate, and instructs the relay station to use them.

In the present example, it is assumed that 16 QAM is specified as the modulation system. The code length L is decided based on the modulation system and the coding rate being specified, and the bit length of S2. The relay station decides the coding rate of S1 based on the code length L. The coding rate of S1 is (LS1)/L, where the bit length of S1 is LS1. In the present example, S1 is coded and gives S1+P1+P2+P3, and S2 is coded and gives S2+P4. P1, P2, P3 denote the parity bit of S1, and P4 denotes the parity bit of S2.

The relay station separates the code word that is coded from S1 into important bits and unimportant bits. In FIG. 9, the relay station separates the code word of S1 into S1+P1 and P2+P3. Both S1+P1 and P2+P3 have a code length of L/2. Here, S1+P1 are decided as the important bits because they contain the systematic bit, and P2+P3 are decided as the bits that are not so important because they contain merely the parity bit.

The relay station changes the bit arrangement in such a manner that the important bit of the code word of S1 comes to the position of the quadrant discrimination of the constellation of 16 QAM. In the present example, the constellation shown in FIG. 2 is employed. As described above, in the constellation shown in FIG. 2, the bits used for the quadrant discrimination are the first bit and the second bit. The relay station arranges the important bits (S1+P1) at the first bit and the second bit as the object of the quadrant discrimination, and arranges the unimportant bits (P2+P3) at the third bit and the fourth bit.

The first bit and the second bit, which are decided according to the quadrant, have such a feature that the tolerance for the noise and the interference is higher than the third bit and fourth bit, which decide the inside or the outside of the constellation, and thus the receiving reliability becomes higher. As a result, when the important bits are arranged at the first bit and the second bit, the receiving reliability of the important bits can be improved.

### Example of 8 PSK Operation

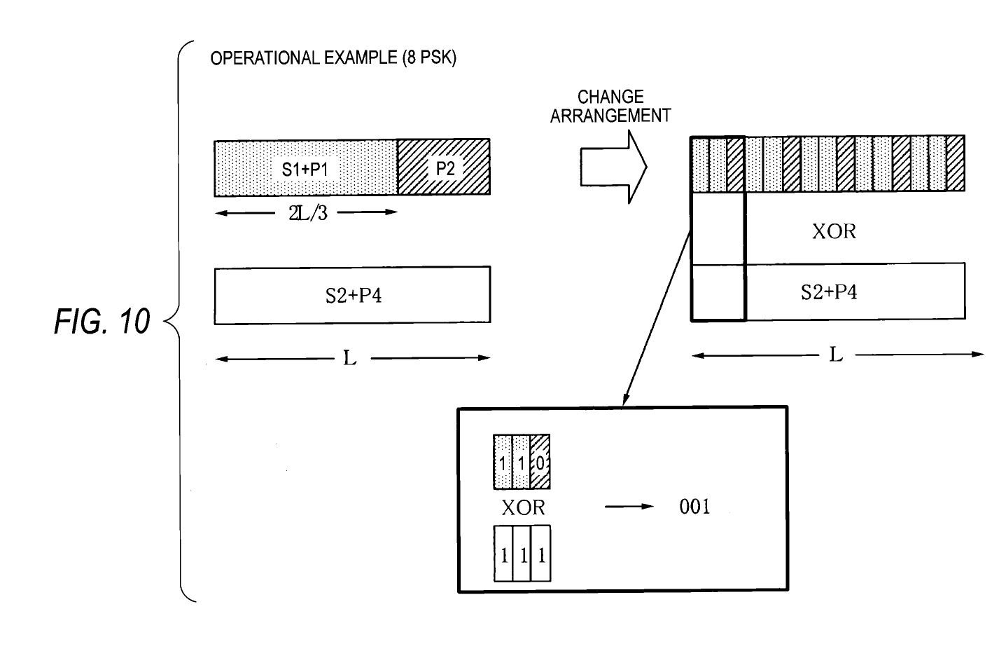

An operational example when the modulating system is 8 PSK is shown in FIG. 10. The relay station receives the signal S1 from the mobile station and receives the signal S2 from the base station, then applies the network coding to two signals, and then transfers the calculated result. In the present example, it is assumed that 8 PSK is specified as the modulating system. The code length L is decided based on the modulation system and the coding rate being specified, and the bit length of S2.

The relay station decides the coding rate of S1 from the code length L.

The coding rate of S1 is (LS1)/L, where the bit length of S1 is LS1. In the present example, S1 is coded and gives S1+P1+P2, and S2 is coded and gives S2+P4. Here, P1, P2 denote the parity bit of S1, and P4 denotes the parity bit of S2.

The relay station separates the code word that is coded from S1 into important bits and unimportant bits. In FIG. 10, the relay station separates the code word of S1 into S1+P1 and P2. The code length of S1+P1 is 2L/3 and the code length of P2 is L/3. Here, S1+P1 are decided as the important bits because they contain the systematic bit, and P2 is decided as the bit that is not so important because it contains merely the parity bit.

The relay station changes the bit arrangement in such a manner that the important bit of the code word of S1 comes to the position of the quadrant discrimination of the constellation of 8 PSK. In the present example, the constellation shown in FIG. 3 is employed.

In the constellation shown in FIG. 3, the bits used for the quadrant discrimination are the first bit and the second bit. The relay station arranges the important bits (S1+P1) at the first bit and the second bit as the object of the quadrant discrimination, and arranges the unimportant bit (P2) at the third bit.

At this time, like the 16 QAM, the first bit and the second bit act as the bits that decides the quadrant on the coordinate axes of the constellation. As a result, when the important bits are arranged at the first bit and the second bit, the receiving reliability of the important bits can be improved.

### Example of 64 QAM Operation

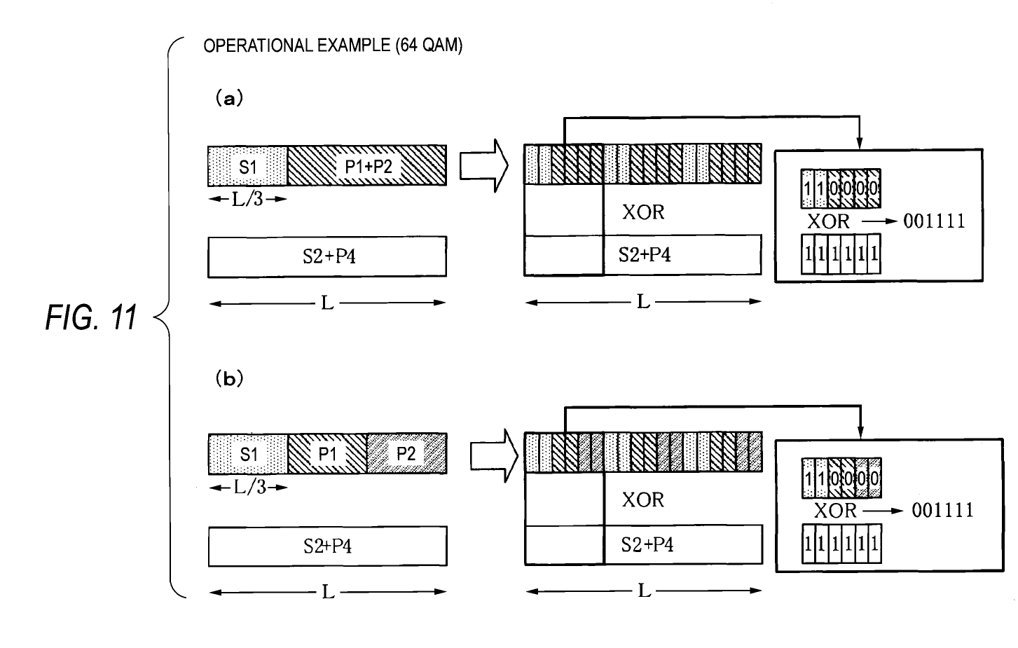

Two patterns of an operational example when a modulating system is 64 QAM are shown in FIGS. 11(a), (b) respectively. The relay station receives the signal S1 from the mobile station and receives the signal S2 from the base station, then applies the network coding to two signals, and then transfers the calculated result.

The relay station decides the coding rate of S1 based on the code length L. The coding rate of S1 is (LS1)/L, where the bit length of S1 is LS1. In the present example, S1 is coded and gives S1+P1+P2, and S2 is coded and gives S2+P4. Here, P1, P2 denote the parity bit of S1, and P4 denotes the parity bit of S2.

In a pattern 1 shown in FIG. 11(a), the relay station separates the code word that is coded from S1 into important bits and unimportant bits. In FIG. 11(a), the relay station separates the code word of S1 into S1 and P1+P2. The code length of S1 is L/3 and the code length of P1+P2 is 2 L/3.

Here, S1 is decided as the important bits because it contains the systematic bit, and P1+P2 are decided as the bits that are not so important because it contains merely the parity bit. The relay station changes the bit arrangement in such a manner that the important bit of the code word of S1 comes to the position of the quadrant discrimination of the constellation of 64 QAM.

In the present example, the constellation shown in FIG. 5 is employed. In the constellation shown in FIG. 5, the bits used for the quadrant discrimination are the first bit and the second bit. The relay station arranges the important bit (S1) at the first bit and the second bit as the object of the quadrant discrimination, and arranges the unimportant bits (P1+P2) at the third to sixth bits.

In a pattern 1 shown in FIG. 11(b), the relay station separates the code word that is coded from S1 into the important bit, the next important bit, and the bit that is not so important. In FIG. 11(b), the relay station separates the code word of S1 into S1, P1, and P2. Respective code lengths are L/3. Here, S1 is assumed as the important bit because this bit is the systematic bit, P1 is assumed as the next important bit, and P2 is assumed as the bit that is not so important.

The relay station arranges the code word of S1 such that the important bit is located at the first and second bits acting as the object of the constellation of the 64 QAM, the next important bit is located at the bit that splits roughly the I axis and the bit that splits roughly the Q axis, and the bit that is not so important is located at the remaining bits.

In the present example, the constellation shown in FIG. 5 is employed. In the constellation shown in FIG. 5, the first bit and the second bit correspond to the bit used for the quadrant discrimination, and the third bit and the fourth bit correspond to the bits that split roughly the I axis and the Q axis respectively. The relay station arranges the important bit (S1) at the first bit and the second bit used for the quadrant discrimination, arranges the next important bit (P1) at the third bit and the fourth bit, and arranges the unimportant bit (P2) at the fifth bit and the sixth bit.

At this time, like the 16 QAM, the first bit and the second bit act as the bits that decides the quadrant on the coordinate axes of the constellation. As a result, when the important bits are arranged at the first bit and the second bit, the receiving reliability of the important bits can be improved.

### [Block Diagram of Relay Station]

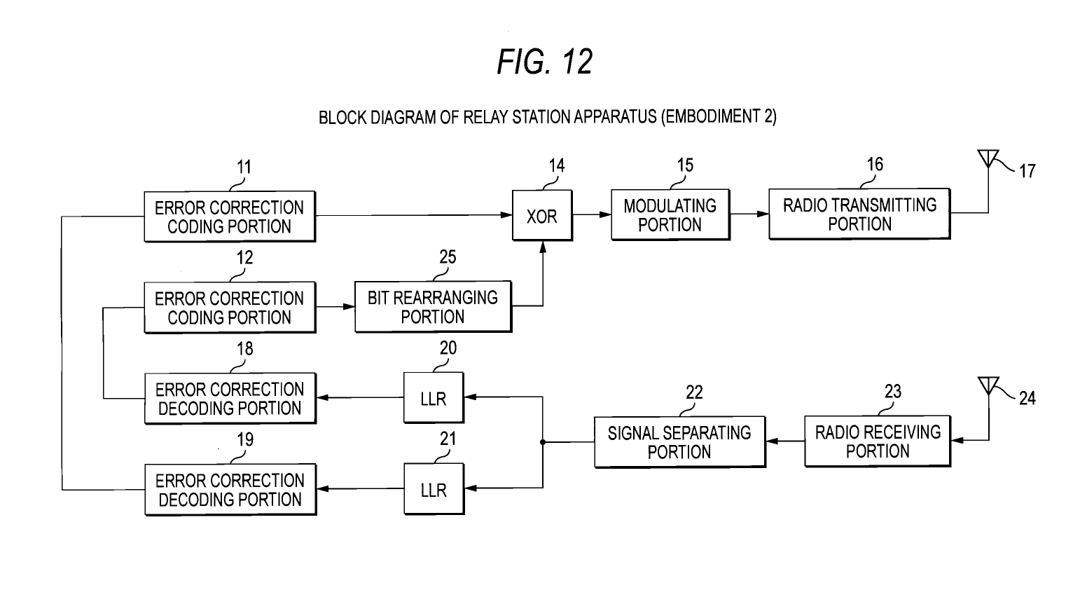

FIG. 12 is a block diagram showing a configuration of a relay station apparatus according to the present embodiment. The radio receiving portion 23 receives the signal Si from the mobile station and the signal S2 from the base station via the antenna 24, applies the radio process such as down-convert, or the like to the signals, and outputs the processed signal the signal separating portion 22.

The signal separating portion 22 separates the signal 51 received from the mobile station and the signal S2 received from the base station. The separated signals are output to the LLR portions 20, 21 respectively. The LLR portions 20, 21 calculate the logarithmic likelihood ratio (LLR: Log Likelihood Ratio) as the soft decision value to the signal S1 received from the mobile station and the signal S2 received from the base station respectively, and outputs the logarithmic likelihood ratio to the error correction decoding portions 18, 19.

The error correction decoding portions 18, 19 apply the error correction decoding to the signal S1 from the mobile station and the signal S2 from the base station by using the LLR. The error correction coding portions 11, 12 apply the error correction coding to the signals that are subjected to the error correction decoding in the error correction decoding portions 18, 19, and output the coded signal to the XOR portion 14 via a bit rearranging portion 25 or output the coded signal to the XOR portion 14 directly. The bit rearranging portion 25 rearranges the bit arrangement such that the signals, a degree of importance of which is high, out of the coded signals come to the bit position of the quadrant discrimination, and outputs the rearranged signal to the XOR portion 14.

The XOR portion 14 applies the XOR operation to both the signal that is subjected to the error correction coding in the upper link and the signal in which the bits are rearranged after the error correction coding is applied in the lower link, and then outputs the resultant signal to the modulating portion 15. The modulating portion 15 modulates again the XOR operated signal from the mobile station and the signal from the base station, and outputs the modulated signal to the radio transmitting portion 16. The radio transmitting portion 16 applies the radio process such as up-convert, or the like to the modulated signal, and relays/transmits the processed signal to the mobile station and the base station via an antenna 17.

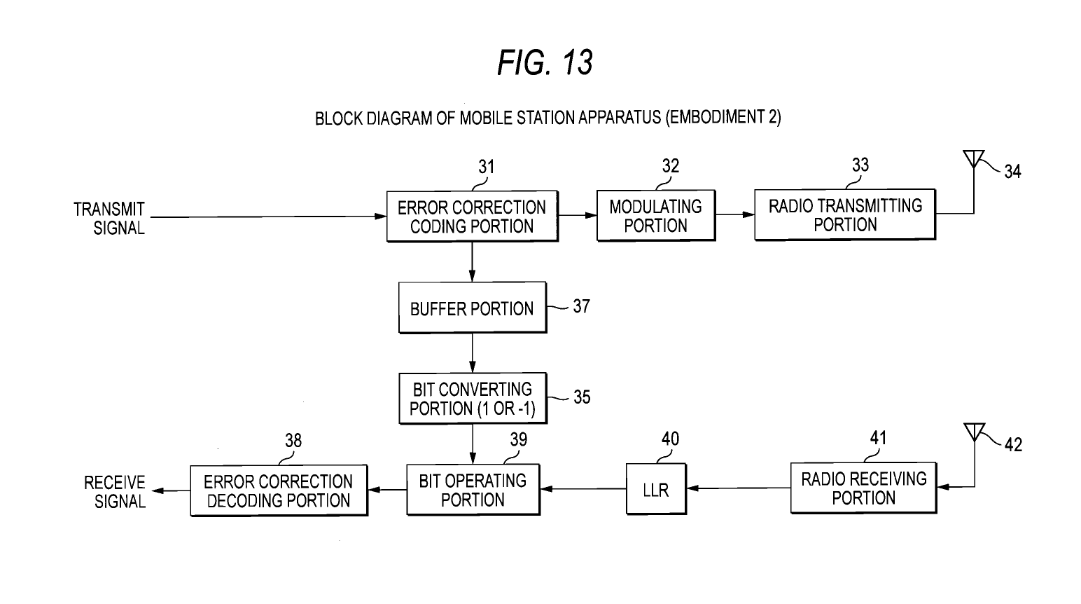

FIG. 13 is a block diagram showing a configuration of a mobile station apparatus according to the present embodiment. An explanation of the similar parts to those of a block diagram of the relay station in FIG. 12 will be omitted herein. The buffer portion 37 saves the signal that is subjected to the error correction coding, and outputs the signal to the bit converting portion 35.

The bit converting portion 35 converts the bit into −1 when the signal being output from the buffer portion 37 is 1 and converts the bit into 1 when such signal is 0, and generates the bit string and then outputs this bit string to the bit operating portion 39. The bit operating portion 39 multiplies the signal being output from the LLR portion 40 by the signal being output from the bit converting portion 35. The multiplied signal is output to the error correction decoding portion 38.

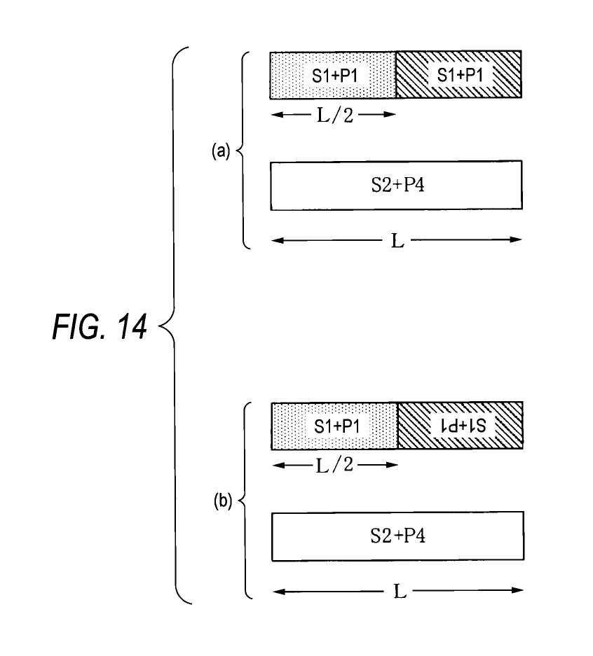

In this case, as the bit which is arranged in the positions except the position for the quadrant discrimination and whose degree of importance is low, the repetition of the bit having the high degree of importance may be employed (see FIG. 14(a)). Also, when the repetition of the bit having the high degree of importance as the bit which is arranged in the positions except the position for the quadrant discrimination and having the low degree of importance, the latter half portion of the repetition may be arranged in reverse order, to prevent such an event that the same bits are arranged in the same symbol (see FIG. 14(b)).

Also, when the repetition of the bit having the high degree of importance is used as the bit which is arranged in the positions except the position for the quadrant discrimination and whose degree of importance is low, the latter half portion of the repetition may be shifted or the interleave pattern may be changed, to prevent such an event that the same bits are arranged in the same symbol.

In the present example, the systematic bit is recognized as the bit having the high degree of importance. In this case, the control signal, the sound signal, the signal transmitted for the first time, the bit whose request for delay is severe, and the like may be assigned preferentially to the quadrant discrimination bit, as the bit having the high degree of importance.

In the present example, the bit rearrangement is applied only to the signal being sent from the base station. In this case, the bit rearrangement is applied only to the signal being sent from the mobile station, or the rearrangement may be applied such that the signal having the high degree of bit importance out of both signals comes to the position for the quadrant discrimination.

### Embodiment 3

In the present embodiment, when the network coding is established by using the multilevel modulation while using a combination of the signals transmitted from a mobile station 1 and a mobile station 2 and the signal transmitted from the base station, the user's signals (the signals transmitted from a mobile station 1 and a mobile station 2) are arranged such that the quadrant discrimination bit can be distinguished from other bits. By doing this, when the receiving quality from the mobile station to the relay station is different every user (mobile station), the quadrant discrimination bit can be assigned to the mobile station whose receiving quality is low such that the signal can be received easily from such mobile station.

[System Diagram]

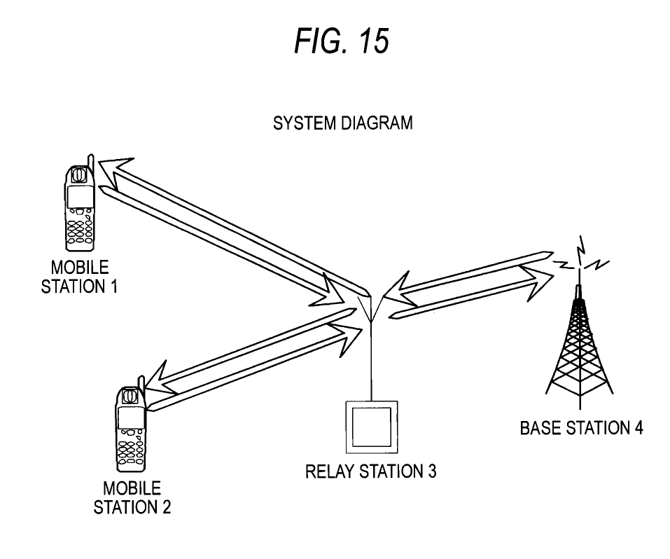

A system diagram is shown in FIG. 15. The mobile station 1 and the mobile station 2 transmit the signal being addressed to a base station 4 to a relay station 3 respectively, and the relay station 3 relays the signals received from the mobile stations 1, 2 to the base station 4. Also, the base station 4 transmits the signals being addressed to the mobile station 1 and the mobile station 2 to the relay station 3. Out of the signals that are received from the base station 4, the relay station 3 relays the signal addressed to the mobile station 1 to the mobile station 1 and relays the signal addressed to the mobile station 2 to the mobile station 2.

[Sequence Diagram]

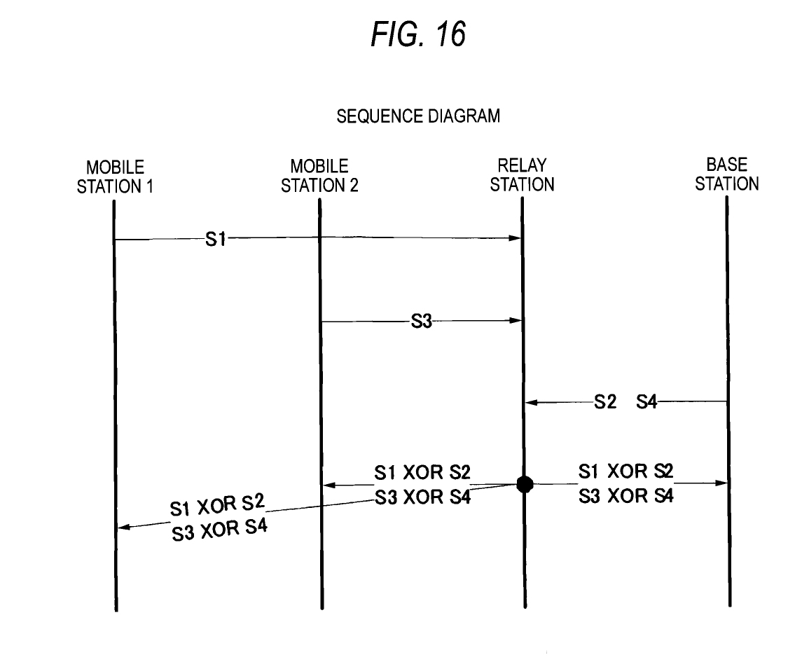

A sequence diagram of the present embodiment is shown in FIG. 16. The mobile station 1 transmits the signal S1 to the relay station 3. The mobile station 2 transmits the signal S3 to the relay station 3. The base station 4 transmits the signals S2 and S4 addressed to the mobile station 1 to the relay station 3. The relay station 3 transmits both the signal obtained by performing the XOR operation of S1 and S3 and the signal obtained by performing the XOR operation of S2 and S4 to the mobile station 1, the mobile station 2, and the base station respectively.

[Operational Chart]

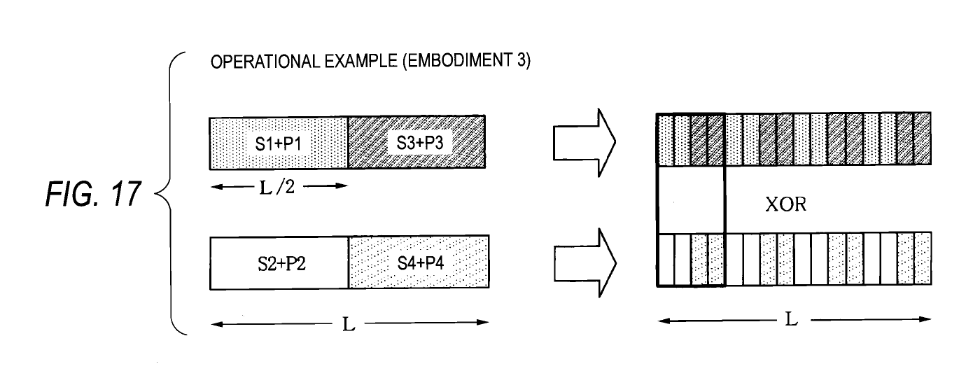

An operational example when a modulating system is 16 QAM is shown in FIG. 17. In this operational example, like Embodiment 2, it is assumed that the coding rate and the code length between the relay station and the mobile station are decided by the instruction issued from the base station, based on the network quality between the relay station and the mobile station. In the present example, S2 is coded and gives S2+P2, and S4 is coded and gives S4+P4. Respective code lengths are L/2, and a total code length of

S2+P2 and S4+P4 is L.

Therefore, when S1 and S3 are coded into S1+P1 and S3+P3 respectively, a length of S1+P1 is set to L/2 to coincide with a length of S2+P2, and a length of S3+P3 is set to L/2 to coincide with a length of S4+P4. After the code lengths of these signals are made uniform, the XOR operation is applied to the combination of S1+P1 and S2+P2 and the combination of S3+P3 and S4+P4 respectively.

Next, the bit arrangement of the signals that are subjected to the XOR operation will be explained by taking as an example the case where the network quality of the mobile station 1 is low in contrast to both the network quality from the relay station 3 to the mobile station 1 and the network quality from the relay station 3 to the mobile station 2. In the present example, the signal for the mobile station 1 whose network quality is low is assigned to the quadrant discrimination bit to improve the receiving quality as high as possible.

Therefore, when the relay is carried out by using the constellation shown in FIG. 2, S1+P1 and S2+P2 are assigned to the first bit and the second bit. Then, S3+P3 and S4+P4 are assigned to the third bit and the fourth bit except the quadrant discrimination bit. The relay station 3 performs the XOR operations of these assigned bits respectively, and applies the 16 QAM to the XOR-operated signals and then relays them. By doing this, the signal for the mobile station 1 whose network quality is low can be arranged in the position of the quadrant discrimination bit, and therefore the receiving quality can be improved.

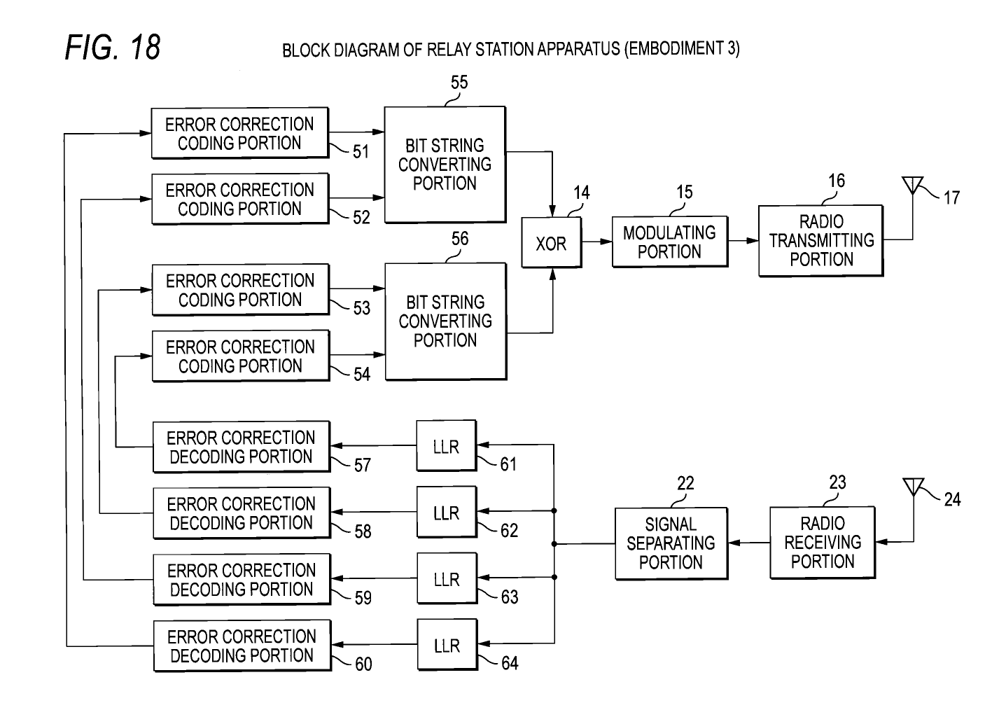

FIG. 18 is a block diagram showing a configuration of a relay station apparatus according to the present embodiment. The signal separating portion 22 separates the signal received via the antenna 24 into four types of signals. Four types of signals are the signal S1 received from the mobile station 1 and addressed to the base station 4, the signal S3 received from the mobile station 2 and addressed to the base station 4, the signal S2 received from the base station 4 and addressed to the mobile station 1, and the signal S4 received from the base station 4 and addressed to the mobile station 2.

In bit string converting portions 55, 56, the order of the bit string of the coded signal of the signal S1 received from the mobile station 1 and addressed to the base station 4 and the coded signal of the signal S3 received from the mobile station 2 and addressed to the base station 4 is converted. The converting method converts the order of the bit string such that the bit whose network quality between the relay station and the mobile station is worse comes to the position for the quadrant discrimination. Similarly, the order of the bit string of the coded signal of the signal S2 received from the base station 4 and addressed to the mobile station 1 and the signal S4 received from the base station 4 and addressed to the mobile station 2 is converted.

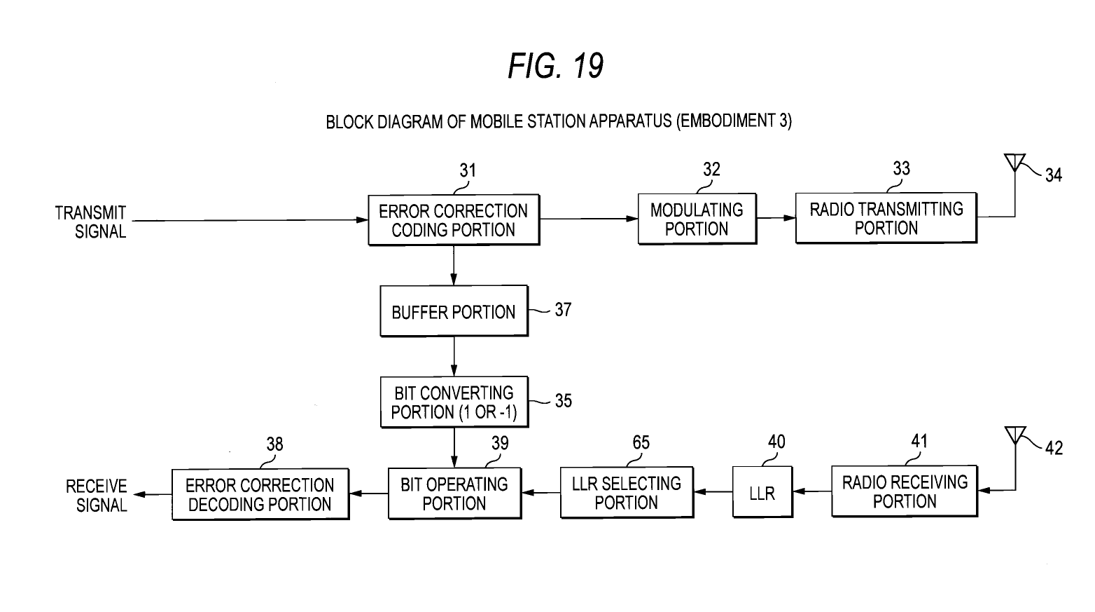

FIG. 19 is a block diagram showing a configuration of a mobile station apparatus according to the present embodiment. The case of the mobile station whose network quality is decided as high will be explained hereunder. An explanation of the similar parts to those of a block diagram shown in FIG. 13 will be omitted herein. Also, the receiving method of the mobile station whose network quality is decided as low is similar to that in Embodiment 2, and therefore its explanation will be omitted herein. An LLR selecting portion 65 selects LLR corresponding to the bit other than the quadrant discrimination bit. In the constellation shown in FIG. 2, the third bit and the fourth bit are selected.

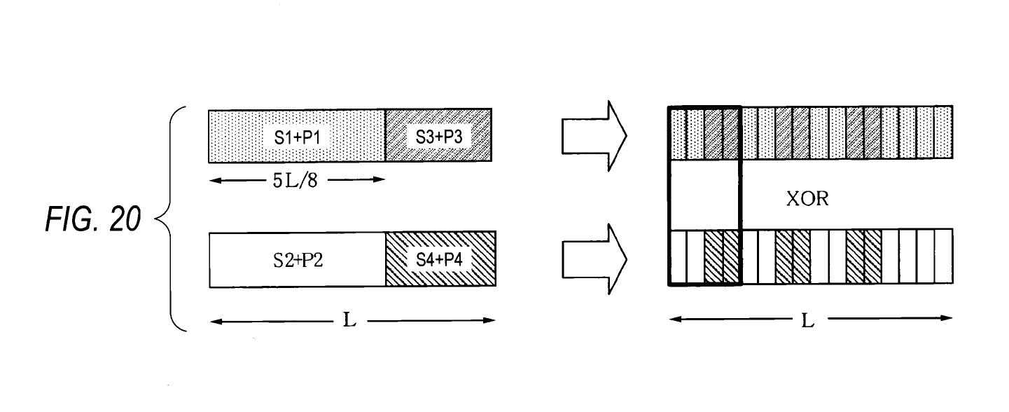

In this case, an example in which both code lengths of the signal directed to the mobile station 1 and the signal directed to the mobile station 2 are equal is illustrated. As shown in FIG. 20, when the code lengths of both signals are different, the quadrant discrimination bit may be assigned preferentially to the mobile station whose network quality is bad. The rule of assigning order may be decided previously between the base station, the relay station, and the mobile station. Also, it may be decides by the instruction given from the base station which signal of the signals sent from the mobile station 1 and the mobile station 2 should be transmitted to the position for the quadrant discrimination, or the relay station may decide which signal of the signals sent from the mobile station 1 and the mobile station 2 should be transmitted to the position for the quadrant discrimination, based on the measured result of the network quality.

As explained above, a radio communication apparatus (relay station 3) according to the third embodiment of the present invention, for making a reception of a first signal from a first mobile station (mobile station 1), a reception of a second signal from a second mobile station (mobile station 2), a reception of a third signal from a base station, and a transmission of a fourth signal to the first mobile station and the second mobile station and the base station, includes a logarithmic likelihood ratio calculating portion for comparing a network quality of the first signal with a network quality of the second signal; a bit string converting portion for arranging a code word of a signal, a network quality of which is low, out of the first signal and the second signal in a quadrant discrimination bit; and an exclusive logical sum operating portion for generating the fourth signal by performing an exclusive logical sum operation of a code word of the first signal and a code word of the third signal and an exclusive logical sum operation of a code word of the second signal and a code word of the third signal bit by bit.

According to the above configuration, the network qualities of the first signal and the second signal are compared with each other, and then the code word of the signal whose network quality is low out of the first signal and the second signal is arranged in the quadrant discrimination bit. Therefore, when the receiving quality between the mobile station and the relay station is different every user, the receiving quality can be improved by arranging the signal for the mobile station whose network quality is low in the position for the quadrant discrimination.

The present invention is explained in detail with reference to the particular embodiments. But it is obvious for those skilled in the art that various variations and modifications can be applied without departing from a spirit and a scope of the present invention.

This application is based upon Japanese Patent Application (Patent Application No. 2007-301658) filed on Nov. 21, 2007; the contents of which are incorporated herein by reference.

### INDUSTRIAL APPLICABILITY

The present invention possesses such an advantage that receiving reliability of predetermined bits such as bits whose degree of importance is high, etc. can be improved, and is available for the radio communication apparatus, the radio communication method, and the radio communication system, and others.

1. A radio communication apparatus for performing a reception of a first signal from a first radio communication apparatus, a reception of a second signal from a second radio communication apparatus, and a transmission of a third signal to the first radio communication apparatus and the second radio communication apparatus, comprising:
an exclusive logical sum operating section that generates the third signal by performing an exclusive logical sum operation of a code word of the second signal and a code word of the first signal, which is arranged in a position of a quadrant discrimination bit in a multilevel modulation, bit by bit on a basis of a code length of the second signal.

2. The radio communication apparatus according to claim 1, further comprising:
a zero padding section that inserts a zero into bit positions except the position of the quadrant discrimination bit in a bit string of the code word of the first signal so that a code length of the first signal becomes equal to a code length of the second signal.

3. The radio communication apparatus according to claim 1, wherein the exclusive logical sum operating section generates the third signal by performing the exclusive logical sum operation of the code word of the second signal and the code word of the first signal, in which predetermined bits are arranged in the position of the quadrant discrimination bit and a bit except the predetermined bits is arranged in a bit position except the quadrant discrimination bit, bit by bit.

4. The radio communication apparatus according to claim 3, further comprising:
a bit rearranging section that arranges a bit, having a high degree of importance, of the code word of the first signal in the position of the quadrant discrimination bit.

5. The radio communication apparatus according to claim 4, wherein the bit rearranging section arranges any bit of a signal containing a systematic bit, a control signal, a sound signal, and a signal transmitted for a first time in the position of the quadrant discrimination bit.

6. The radio communication apparatus according to claim 3, wherein a bit string length of the predetermined bits arranged in the position of the quadrant discrimination bit is within 2 L/(log₂M), where L is a length of the bit string that is subjected to the exclusive logical sum operation, and M is a number of multilevel in the multilevel modulation.

7. A radio communication method of performing a reception of a first signal from a first radio communication apparatus, a reception of a second signal from a second radio communication apparatus, and a transmission of a third signal to the first radio communication apparatus and the second radio communication apparatus, comprising:
an exclusive logical sum operating step of generating the third signal by performing an exclusive logical sum operation of a code word of the second signal and a code word of the first signal, which is arranged in a position of a quadrant discrimination bit in a multilevel modulation, bit by bit on a basis of a code length of the second signal.

8. The radio communication method according to claim 7, further comprising:
a zero padding step of inserting a zero into bit positions except the position of the quadrant discrimination bit in a bit string of the code word of the first signal so that a code length of the first signal becomes equal to a code length of the second signal.

9. The radio communication method according to claim 7, wherein in the exclusive logical sum operating step, the third signal is generated by performing the exclusive logical sum operation of the code word of the second signal and the code word of the first signal, in which predetermined bits are arranged in the position of the quadrant discrimination bit and a bit except the predetermined bits is arranged in a bit position except the quadrant discrimination bit, bit by bit.

10. The radio communication method according to claim 9, further comprising:
a bit rearranging step of arranging a bit, having a high degree of importance, of the code word of the first signal in the position of the quadrant discrimination bit.

11. The radio communication method according to claim 10, wherein in the bit rearranging step, any bit of a signal containing a systematic bit, a control signal, a sound signal, and a signal transmitted for a first time is arranged in the position of the quadrant discrimination bit.

12. The radio communication method according to claim 9, wherein a bit string length of the predetermined bits arranged in the position of the quadrant discrimination bit is within 2 L/(log₂M), where L is a length of the bit string that is subjected to the exclusive logical sum operation, and M is a number of multilevel in the multilevel modulation.

13. (canceled)
